(19) United States
(12) Patent Application Publication
(10) Pub. No.: US 2007/0226718 A1
(43) Pub. Date: Sep. 27, 2007

(54) Method and apparatus for supporting software tuning for multi-core processor, and computer product

(75) Inventor: Manabu Watanabe, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/501,870

(22) Filed: Aug. 10, 2006

(30) Foreign Application Priority Data
Mar. 27, 2006 (JP) 2006-085471

(51) Int. Cl. G06F 9/45

(52) U.S. Cl. 717/151

(57) ABSTRACT

A granularity information acquiring unit acquires information on granularity assigned to each core. A structure information creating unit calculates frequency of appearance for each task or for each function included in the task based on the granularity information, and creates information on the frequency. A dependence information creating unit creates information on dependence on other tasks or other functions for each task or for each function included in the task based on the granularity information. An output unit outputs each of above information.

### CROSS-REFERENCE TO RELATED APPLICATIONS

This application is based upon and claims the benefit of priority from the prior Japanese Patent Application No. 2006-085471, filed on Mar. 27, 2006, the entire contents of which are incorporated herein by reference.

### BACKGROUND OF THE INVENTION

1. Field of the Invention

The present invention relates to a technology for supporting tuning of software for a multi-core processor.

2. Description of the Related Art

A multi-core processor that integrates a plurality of cores on one chip to distribute a load of some functions in terms of hardware is a conventionally know technology (for example, Japanese Patent Application Laid-Open Publication No. 2002-117011). Moreover, a method in which, at the time of tuning, an order of execution of tasks is determined and dynamic assignment of tasks to processors is performed is conventionally known (for example, Japanese Patent Application Laid-Open Publication No. H8-292932).

To improve the operation rate of each core by distributing the load of such process, in the tuning of the multi-core processor, an algorithm or logic of the tasks is modified, or the tasks are divided or combined.

However, in this conventional method of tuning, the tuning is executed without grasping the static granularity. Therefore, it is not easy for engineers to grasp, during tuning, the extent of the influence caused by the tuning. As a result, the operation rate of the cores can be reduced by executing the tuning, and efficiency of the multi-core processor is rather degraded.

### SUMMARY OF THE INVENTION

It is an object of the present invention to at least solve the above problems in the conventional technologies.

A tuning support apparatus according to one aspect of the present invention supports software tuning for a multi-core processor having a plurality of cores. The tuning support apparatus includes an acquiring unit configured to acquire granularity information on granularity assigned to each core; and an output unit configured to output the granularity information.

A tuning support apparatus according to another aspect of the present invention supports software tuning for a multi-core processor having a plurality of cores. The tuning support apparatus includes an acquiring unit configured to acquire granularity information on granularity assigned to each core; a creating unit configured to calculate a frequency of appearance for each task or for each function included in a task, based on the granularity information, and to create structure information indicative of the frequency; and an output unit configured to output at least the structure information among the structure information and the granularity information.

A tuning support apparatus according to still another aspect of the present invention supports software tuning for a multi-core processor having a plurality of cores. The tuning support apparatus includes an acquiring unit configured to acquire granularity information on granularity assigned to each core; a creating unit configured to create dependence information on dependence on other tasks or functions for each task or for each function included in a task, based on the granularity information; and an output unit configured to output at least the dependence information among the dependence information and the granularity information.

A tuning support method according to still another aspect of the present invention is of supporting software tuning for a multi-core processor having a plurality of cores. The tuning support method includes acquiring granularity information on granularity assigned to each core; and outputting the granularity information.

A tuning support method according to still another aspect of the present invention is of supporting software tuning for a multi-core processor having a plurality of cores. The tuning support method includes acquiring granularity information on granularity assigned to each core; calculating a frequency of appearance for each task or for each function included in a task, based on the granularity information; creating structure information indicative of the frequency; and outputting at least the structure information among the structure information and the granularity information.

A tuning support method according to still another aspect of the present invention is of supporting software tuning for a multi-core processor having a plurality of cores. The tuning support method includes acquiring granularity information on granularity assigned to each core; creating dependence information on dependence on other tasks or functions for each task or for each function included in a task, based on the granularity information; and outputting at least the dependence information among the dependence information and the granularity information.

A computer-readable recording medium according to still another aspect of the present invention stores a computer program for realizing a tuning support method according to the above aspects.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a tuning support apparatus according to an embodiment of the present invention;

FIG. 2 is a block diagram of the tuning support apparatus according to the embodiment;

FIG. 3 is a flowchart of a program creating process by a multi-core processor;

FIG. 4 is a schematic for illustrating granularity information of Task1;

FIG. 5A is a schematic for illustrating a program list of func1 of Task1 shown in FIG. 4;

FIG. 5B is a schematic for illustrating a program list of func2 of Task1 shown in FIG. 4;

FIG. 5C is a schematic for illustrating a program list of func3 of Task1 shown in FIG. 4;

FIG. 6 is a schematic for illustrating granularity information of Task2;

FIG. 7A is a schematic for illustrating a program list of funcm of Task2 shown in FIG. 6;

FIG. 7B is a schematic for illustrating a program list of funcn of Task2 shown in FIG. 6;

FIG. 8 is a schematic for illustrating granularity information of Task3;

FIG. 9A is a schematic for illustrating a program list of funca of Task3 shown in FIG. 8;

FIG. 9B is a schematic for illustrating a program list of funcb of Task3 shown in FIG. 8;

FIG. 9C is a schematic for illustrating a program list of funcc of Task3 shown in FIG. 8;

FIG. 9D is a schematic for illustrating a program list of funcd of Task3 shown in FIG. 8;

FIG. 9E is a schematic for illustrating a program list of funce of Task3 shown in FIG. 8;

FIG. 9F is a schematic for illustrating a program list of funcf of Task3 shown in FIG. 8;

FIG. 10 is a schematic for illustrating granularity information of Task4;

FIG. 11 is a schematic for illustrating a program list of funcx of Task4 shown in FIG. 10;

FIG. 12 is a table of structure information of Task1 to Task4;

FIG. 13 is a table of dependence information of Task1 to Task4;

FIG. 14A is a schematic for explaining a degree of dependence of Task1;

FIG. 14B is a schematic for explaining a degree of dependence of Task1;

FIG. 15 is a table of load definition;

FIG. 16 is a schematic of an example of a display screen;

FIG. 17 is a schematic of a display example of a result of diagnosis;

FIG. 18 is a schematic of a display example of a result of diagnosis;

FIG. 19A is a schematic for illustrating an example of a tuning process;

FIG. 19B is a schematic for illustrating an example of the tuning process; and

FIG. 20 is a schematic for illustrating an example of the tuning process.

### DETAILED DESCRIPTION OF THE PREFERRED EMBODIMENTS

Exemplary embodiments according to the present invention will be explained in detail below with reference to the accompanying drawings.

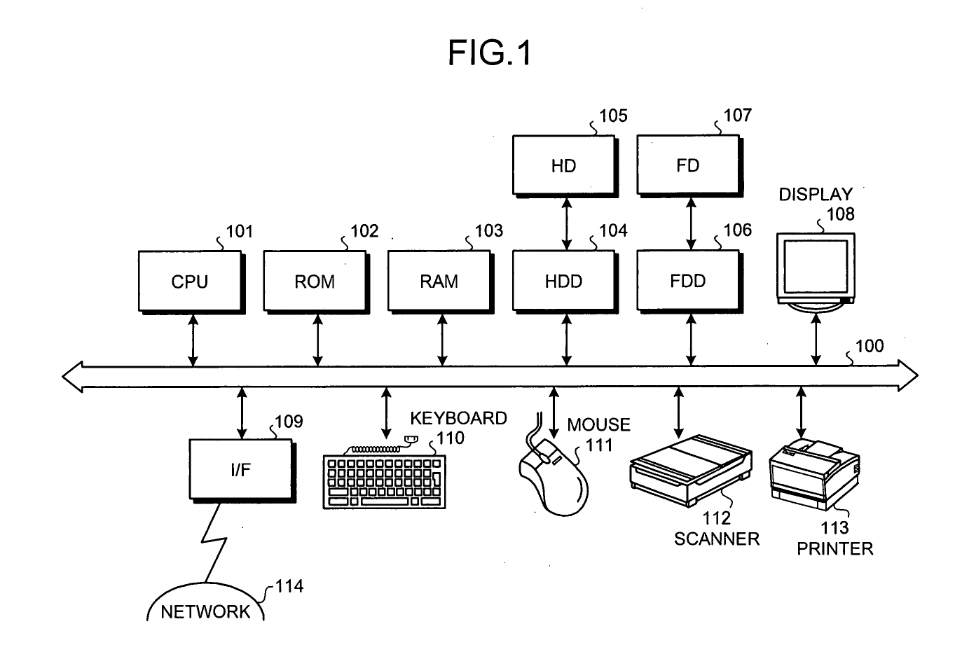

FIG. 1 is a schematic of a tuning support apparatus according to an embodiment of the present invention. The tuning support apparatus includes a central processing unit (CPU) 101, a read-only memory (ROM) 102, a random access memory (RAM) 103, a hard disk drive (HDD) 104, a hard disk (HD) 105, a flexible disk drive (FDD) 106, a flexible disk (FD) 107 as an example of a removable recording medium, a display 108, an interface (I/F) 109, a keyboard 110, a mouse 111, a scanner 112, and a printer 113. Each component is connected via a bus 100 with each other.

The CPU 101 controls the entire tuning support apparatus. The ROM 102 stores programs such as a boot program, etc. The RAM 103 is used as a work area of the CPU 101. The HDD 104 controls reading/writing of data from/to the HD 105 in accordance with a control of the CPU 101. The HD 105 stores data written in accordance with a control of the HDD 104.

The FDD 106 controls reading/writing of data from/to the FD 107 in accordance with a control of the CPU 101. The FD 107 stores the data written by the control of the FDD 106, causes the tuning support apparatus to read the data stored in the FD 107, etc. As a removable recording medium, besides the FD 107, a compact-disc read-only memory (CD-ROM), compact-disc recordable (CD-R), a compact-disc rewritable (CD-RW), a magneto optical (MO) disk, a digital versatile disk (DVD), and a memory card may be used.

In addition to a cursor, and icons or tool boxes, the display 108 displays data such as texts, images, functional information, etc. This display 108 may employ, for example, a cathode ray tube (CRT), a thin film transistor (TFT) liquid crystal display, a plasma display, etc.

The I/F 109 is connected with a network 114 such as the Internet through a communication line and is connected with other apparatuses through this network 114. The I/F 109 administers an internal interface with the network 114 and controls input/output of data to/from external apparatuses. For example, a modem, a local area network (LAN) adaptor, etc., may be employed as the I/F 109.

The keyboard 110 includes keys for inputting letters, digits, various instructions, etc., and executes input of data. The keyboard 110 may be a touch-panel input pad or a numeric key pad, etc. The mouse 111 shifts the cursor, selects a region, or moves and changes a size of windows. The mouse 111 may be a track ball or a joy stick that has a similar function as a pointing device.

The scanner 112 optically reads images and captures image data into the tuning support apparatus. The printer 113 prints image data and text data. For example, a laser printer or an ink jet printer may be employed as the printer 113.

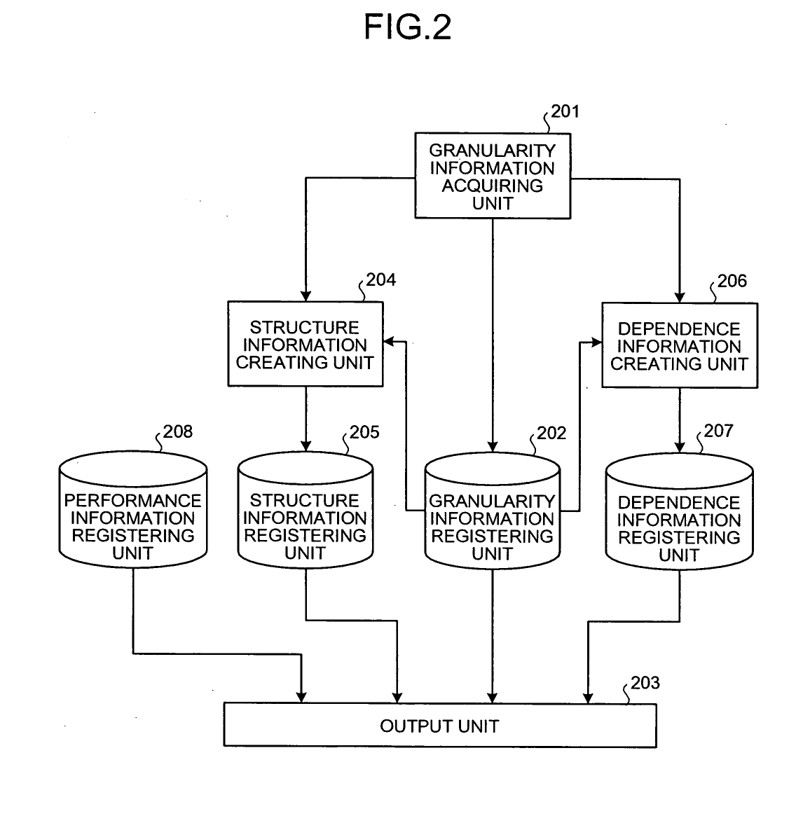

FIG. 2 is a block diagram of the tuning support apparatus. The tuning support apparatus is configured to include a granularity information acquiring unit 201, a granularity information registering unit 202, an output unit 203, a structure information creating unit 204, a structure information registering unit 205, a dependence information creating unit 206, a dependence information registering unit 207, and a performance information registering unit 208.

The granularity information acquiring unit 201 acquires information on the granularity assigned to a multi-core processor that includes a plurality of cores (“granularity information”). “Granularity” in the embodiment is, for example, a unit of processes executed by the processor and may be a generic name of processes that constitute a task, a function, a procedure, etc. Therefore, for example, a “task” may correspond to a relatively large granularity and a “procedure” constituting a task may correspond to a relatively small granularity.

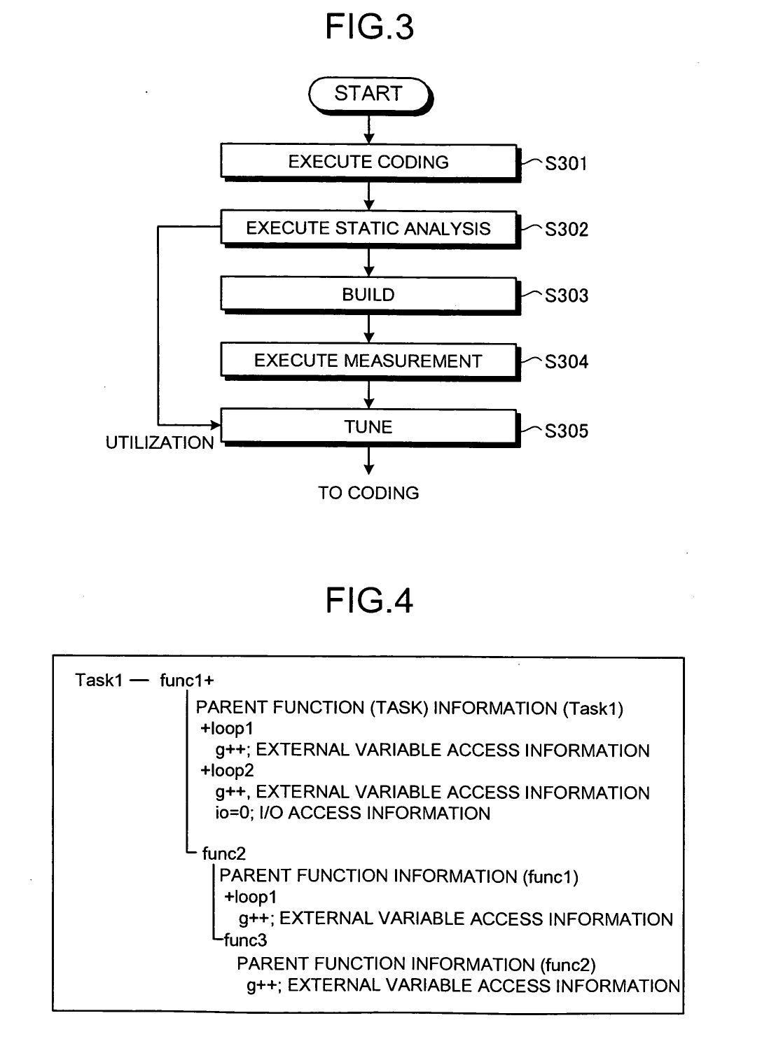

More specifically, the granularity information acquiring unit 201 acquires information necessary for tuning tasks, functions, loops, external variable access information that are assigned to each core as a result of coding a program (step S301) and statically analyzing the coded program (step S302) as shown in FIG. 3 to be described later.

The granularity information acquiring unit 201 realizes the function thereof by causing the CPU 101 to execute a program such as program analyzing software, etc., stored in, for example, the ROM 102, the RAM 103, the HD 105, the FD 107, etc.

The granularity information registering unit 202 registers the granularity information acquired by the granularity information acquiring unit 201. Specifically, the granularity information registering unit 202 realizes the function thereof using the HD 105, the FD 107, etc., shown in FIG. 1.

The output unit 203 outputs the granularity information acquired by the granularity information acquiring unit 201 or the granularity information registered in the granularity information registering unit 202. Specifically, the output unit 203 outputs such information by, for example, displaying on the display 108, printing by the printer 113 shown in FIG. 1, and transmitting to other information processing apparatuses (not shown), using the I/F 109.

The structure information creating unit 204 calculates the number of times of appearance for each task or for each function retained by the task based on the granularity information acquired by the granularity information acquiring unit 201 and creates information (structure information) on the number of times of appearance calculated. In this manner, the structure information is usually created based on the acquired granularity information or the acquired and registered granularity information. A detailed example of the structure information will be described in detail later (see FIG. 12). The structure information creating unit 204 realizes the function thereof by causing the CPU 101 to execute a program stored in, for example, the ROM 102, the RAM 103, the HD 105, the FD 107, etc.

The structure information registering unit 205 registers the granularity information acquired by the structure information creating unit 204. More specifically, the structure information registering unit 205 realizes the function thereof by the HD 105, FD 107, etc.

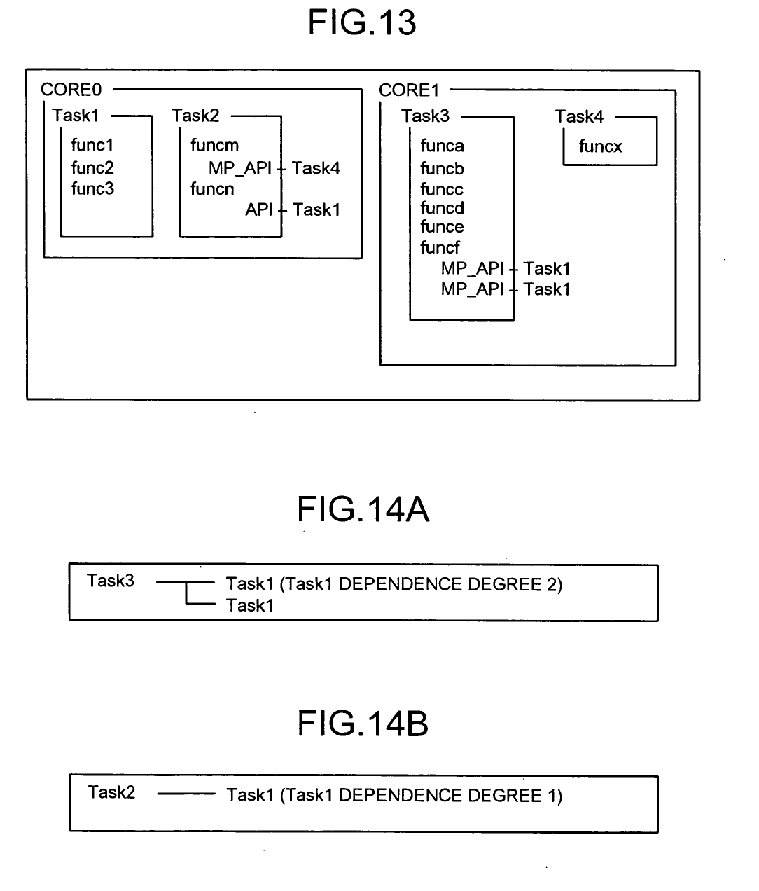

The dependence information creating unit 206 creates information (dependence information) on the dependence on other tasks or functions for each task or for each function included in the task based on the granularity information. In this manner, the dependence information is usually created based on the acquired granularity information or the acquired and registered granularity information. A detailed example of the dependence information will be described later in detail (see FIGS. 13, 14A, and 14B). The dependence information creating unit 206 realizes the function thereof by causing the CPU 101 to execute a program stored in, for example, the ROM 102, the RAM 103, the HD 105, the FD 107, etc.

The dependence information registering unit 207 registers the granularity information acquired by the dependence information creating unit 206. More specifically, the dependence information registering unit 207 realizes the function thereof by the HD 105, the FD 107, etc.

The performance information registering unit 208 registers information (performance information) on a load (weight) set in advance depending on a type of the function. Specifically, the performance information registering unit 208 realizes the function thereof by the HD 105, the FD 107, etc.

FIG. 3 is a flowchart of a program creating process by the multi-core processor. As shown in FIG. 3, coding, which is programming for the multi-core or multi-task processor, is executed (step S301).

Static analysis is executed to the executed programming (step S302). “Static analysis” is, for example, collecting “structure information” and “administration information” necessary for tuning tasks, functions, loops, external access information. “Build”, that is, creation of a target program is executed (step S303), and measurement of the performance is executed (step S304).

A tuning process is executed (step S305). More specifically, the task structure is designated considering the result of the performance measurement at step S304. At this step, information on the static analysis executed at step S302 is utilized. Further coding is executed based on the result of the tuning process.

In the embodiment, granularity information is present for each of four tasks (Task1 to Task4). In the four tasks, Task1 and Task2 are assigned to a first core (CORE0), and Task3 and Task4 are assigned to a second core (CORE1).

FIG. 4 illustrates contents of the granularity information of Task1. As shown in FIG. 4, Task1 includes three functions (func1 to func3). “g++” indicates an increment of an external variable “g”. Thus, a memory access is indicated directly. “io” indicates an I/O address reference and directly indicates an access to an I/O port. It is indicated that “g++” is executed twice in func1, once in func2 and in func3. “io” is executed once in func1.

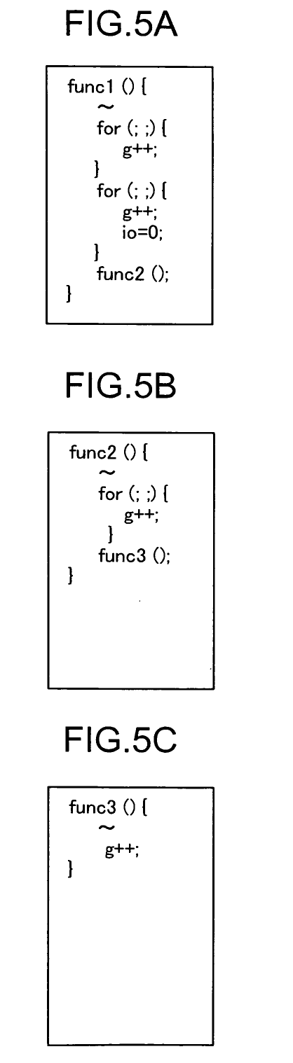

FIG. 5A illustrates a program list of func1 of Task1 shown in FIG. 4. FIG. 5B illustrates a program list of func2 of Task1. FIG. 5C illustrates a program list of func3 of Task1.

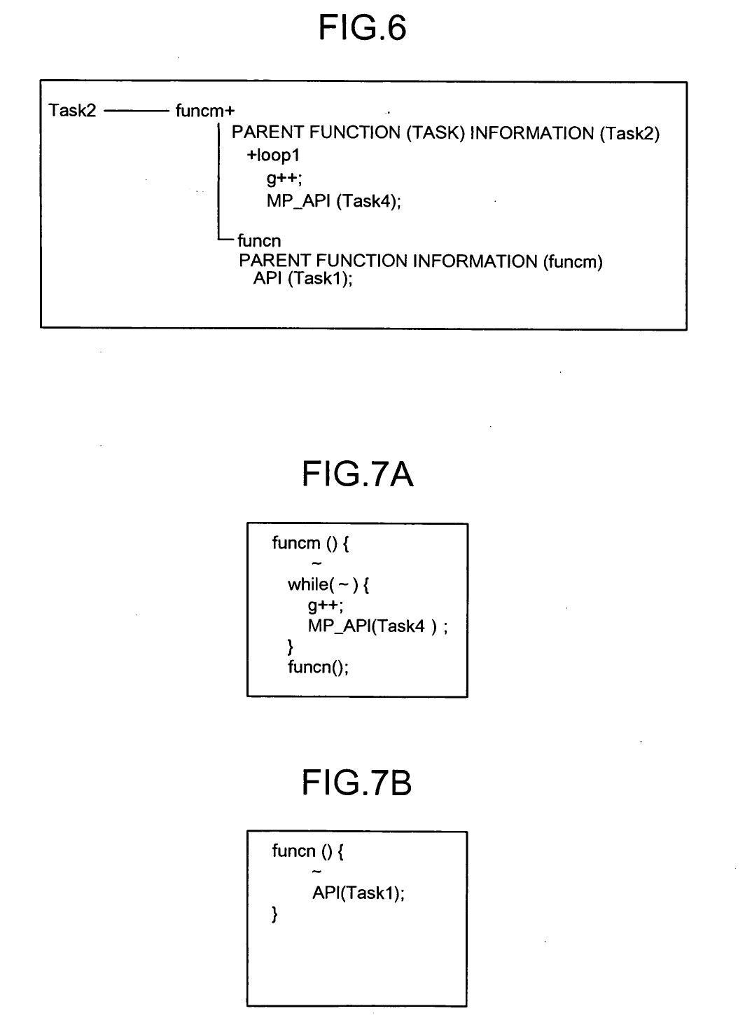

FIG. 6 illustrates contents of the granularity information of Task2. As shown in FIG. 6, Task2 includes two functions (funcm and funcn). “MP_API” is an inter-core (inter-CPU) communication application program interface (API) and indicates reading across cores. “API” is an in-core API and indicates a task switching in a same core. When “MP_API” is compared with “API”, “MP_API” has a heavier load than “API”. “g++” and “MP_API” are respectively executed once for funcm and “API” is executed once for funcn.

FIG. 7A illustrates a program list of funcm of Task2 shown in FIG. 6. FIG. 7B illustrates a program list of funcn of Task2.

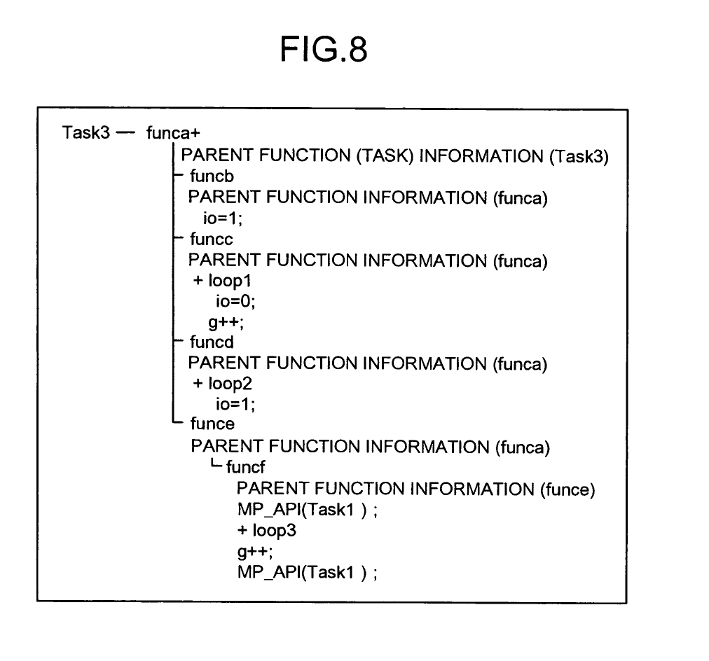

FIG. 8 illustrates contents of the granularity information of Task3. As shown in FIG. 8, Task3 includes six functions (funca to funcf). For “funcb”, “io” is executed once. For “funcc”, “g++” is executed once. For “funcd”, “io” is executed once. For “funcf”, “MP_API” is executed twice and “g++” is executed once.

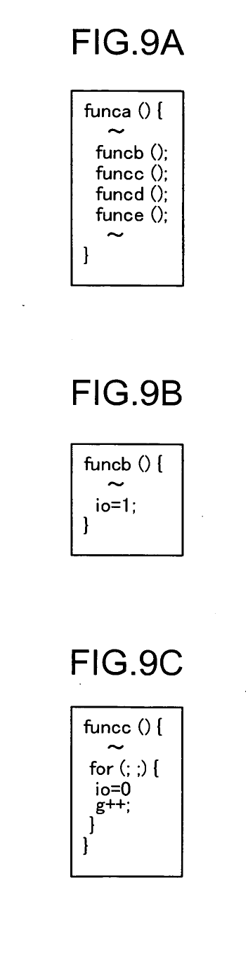

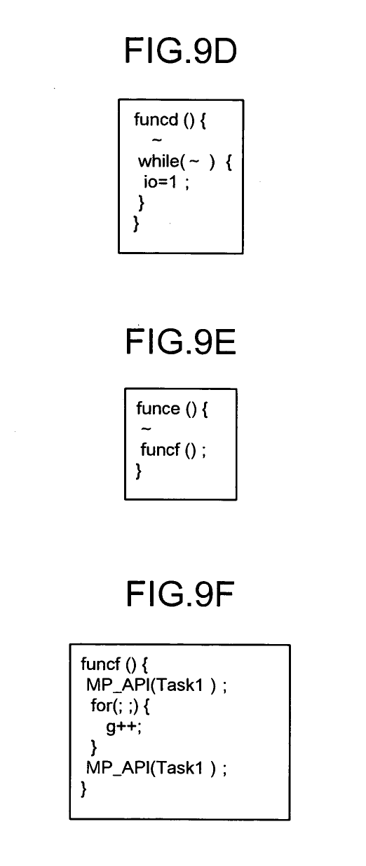

FIG. 9A illustrates a program list of funca of Task3 shown in FIG. 8. FIG. 9B illustrates a program list of funcb of Task3. FIG. 9C illustrates a program list of funcc of Task3. FIG. 9D illustrates a program list of funcd of Task3. FIG. 9E illustrates a program list of funce of Task3. FIG. 9F illustrates a program list of funcf of Task3.

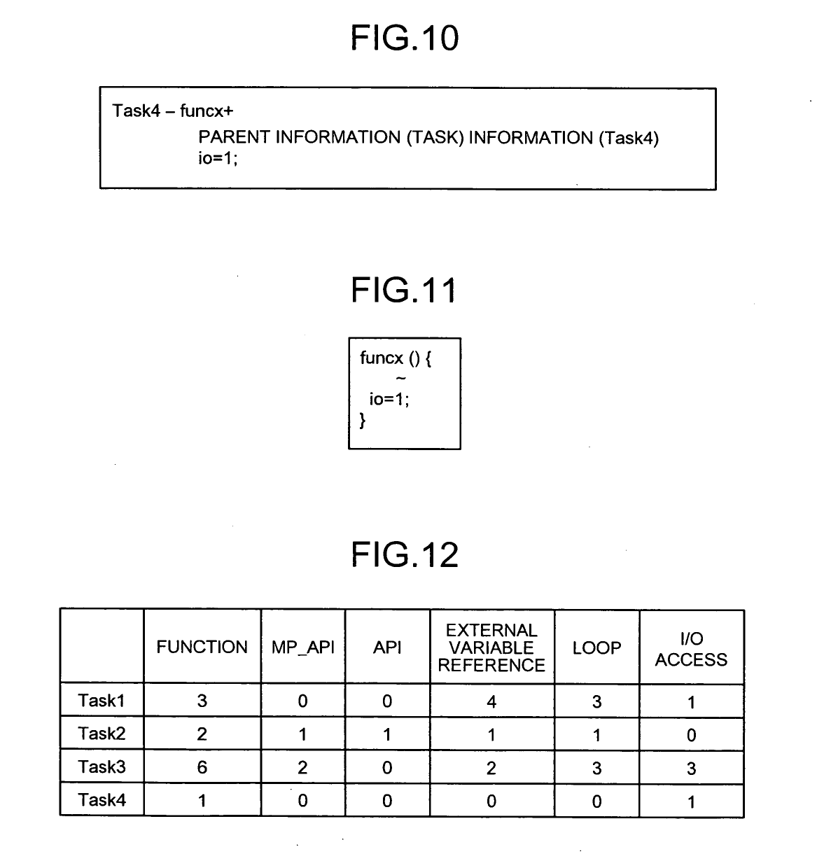

FIG. 10 illustrates contents of the granularity information of Task4. As shown in FIG. 10, Task4 includes one function (funcx). For funcx, “io” is executed once. FIG. 11 illustrates a program list of funcx of Task4 shown in FIG. 10. As described above, the granularity information may include a program list itself. Therefore, an output of the granularity information may include displaying the contents shown in FIGS. 4 to 11.

FIG. 12 illustrates the structure information of Task1 to Task4 and is based on the granularity information described above (FIGS. 4 to 11). As shown in FIG. 12, the structure information administers factors that are dependent on the load (the number of cycles) such as functions, loops, external variable accesses, etc, included in each task for each task or for each function.

The function numbers, that is, the numbers of functions are “3”, “2”, “6”, and “1” respectively for Task1, Task2, Task3, and Task4. For Task1, “MP_API” and “API” are not present, the number of the external variable reference is four times in the total of twice for func1, once for func2, and once for func3. As described above, the number of loops is three in the total of twice for func1 and once for func2. The number of I/O accesses is only once for func1. Task2 and those following Task2 are the same as Task1. The structure information is thus created.

FIG. 13 illustrates the dependence information of Task1 to Task4 based on the granularity information (FIGS. 4 to 11) described above. In FIG. 13, the two cores (CORE0, CORE1) are depicted to have tasks respectively.

The two tasks of Task1 and Task2 are assigned to CORE0. In each task, functions respectively included in the task are displayed together. Information on “MP_API” and “API” (including information on a task from which the information has been read) is also displayed together.

Consequently, it can be easily understood that only three functions (func1, func2, and func3) are present and that “MP_API” and “API” are not present in Task1 surrounded by CORE0. It can be also easily understood that two functions (funcm, funcn) are present in Task2 surrounded by CORE0, that “MP_API” from Task4 is present in funcm, and that “API” that Task1 depends on is present in funcn. Task1 that is assigned to CORE0 retains “MP_API” because Task4 is assigned to CORE1, and Task1 retains “API” because Task1 is assigned to CORE0.

Two tasks of Task3 and Task4 are assigned to CORE1. It can be easily understood that six functions (funca to funcf) are present in Task3 surrounded by CORE1 and twice of “MP_API” that Task1 depends on are present in funcf. Task3 that is assigned to CORE1 retains “MP_API” because Task1 is assigned to CORE0. It can also be easily understood that only one function (funcx) is present and “MP_API” and “API” are not present in Task4 surrounded by CORE1.

FIGS. 14A and 14B illustrate degree of dependence of tasks focusing on Task1. As shown in FIG. 14A, a reading origin task is Task3 and the number of times of reading is two. Therefore, the degree of dependence of Task3 on Task1 is two. As shown in FIG. 14B, similarly to FIG. 14A, a reading origin task is Task2 and the number of times of reading is one. Therefore, the degree of dependence of Task2 on Task1 is one. The precision of the dependence information can be improved more considering dependence between functions and dependence of “MP_API”.

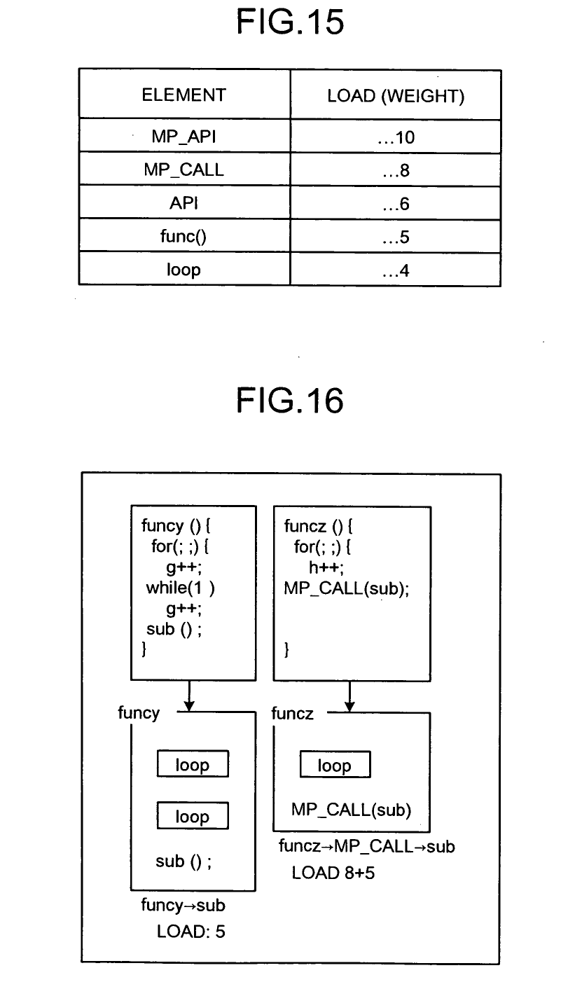

A display function of the tuning support apparatus according to the embodiment will be described. The tuning support apparatus according to the embodiment can define loads such as inter-core communication, task switching, function invocation, loops, etc., and can display the granularity information. FIG. 15 illustrates a load definition table. In the load definition table, a load (weight) is set to each element. A load (weight) may be referred to as the number of cycles of the CPU. “MP_CALL” is function invocation across cores (CPUs) and a case where no OS is used corresponds to this case.

Using this definition table, a load of task invocation or function invocation across cores can be expressed as a hint for the developing engineers to judge on which core a task or a function should be executed. FIG. 16 is an explanatory view showing an example of a display screen.

As shown in FIG. 16, it can be seen that a heavier load is imposed on the relation between funcz ( ) and sub ( ) than the relation between funcy ( ) and sub ( ). That is, when the load to invoke sub ( ) from funcy ( ) is five, because funcz ( ) have to cross cores, to invoke sub ( ), a load “5” to invoke sub ( ) is added to a load “8” of “MP_CALL” and the total of the loads is “13”. In this manner, by displaying the load “5”, “8+5”, etc., the load of invoking tasks across cores or invoking functions can be expressed.

With such a display function, it can be informed to the developing engineers that it is better to actively map funcz ( ) and sub ( ) in a same core and, when possible, to contain in a same task, etc.

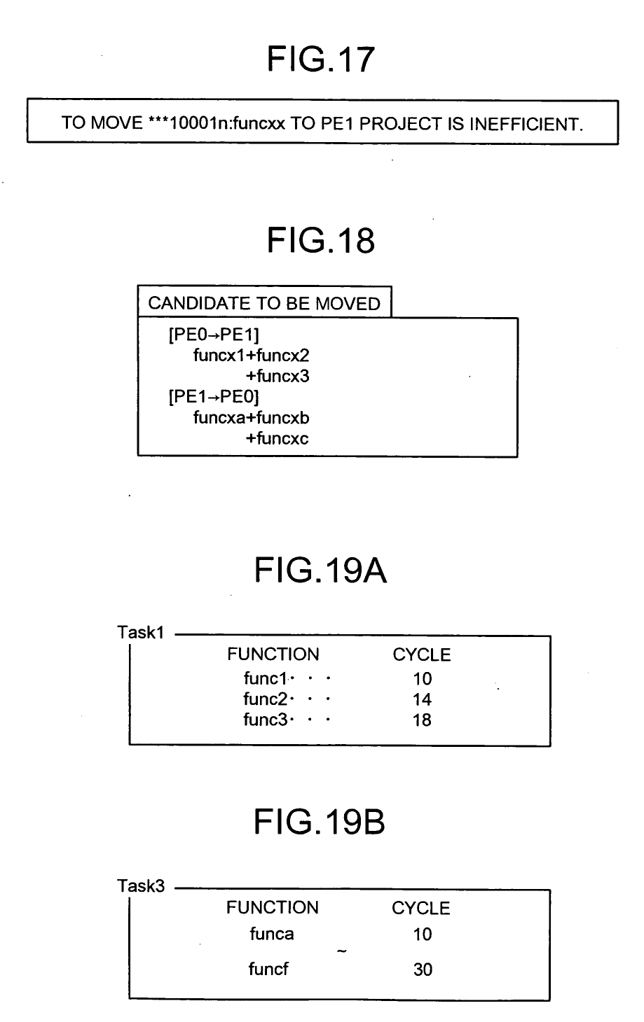

FIGS. 17 and 18 are schematics of a display example of a result of the diagnosis. For example, a guidance, “To move 10001n:funcxx to CORE1 project is inefficient” shown in FIG. 17 may be displayed based on the loads described for the display function above, as a project made into a text.

As shown in FIG. 18, an example of candidates to be moved may be displayed as the result of the diagnosis. In FIG. 18, “funcx1+funcx2+cuncx3” is exemplified as candidates to be moved from PE0 (CORE0) to PE1 (CORE1), and “funcxa+funcxb+cuncxc” is exemplified as candidates to be moved from PE1 (CORE1) to PE0 (CORE0).

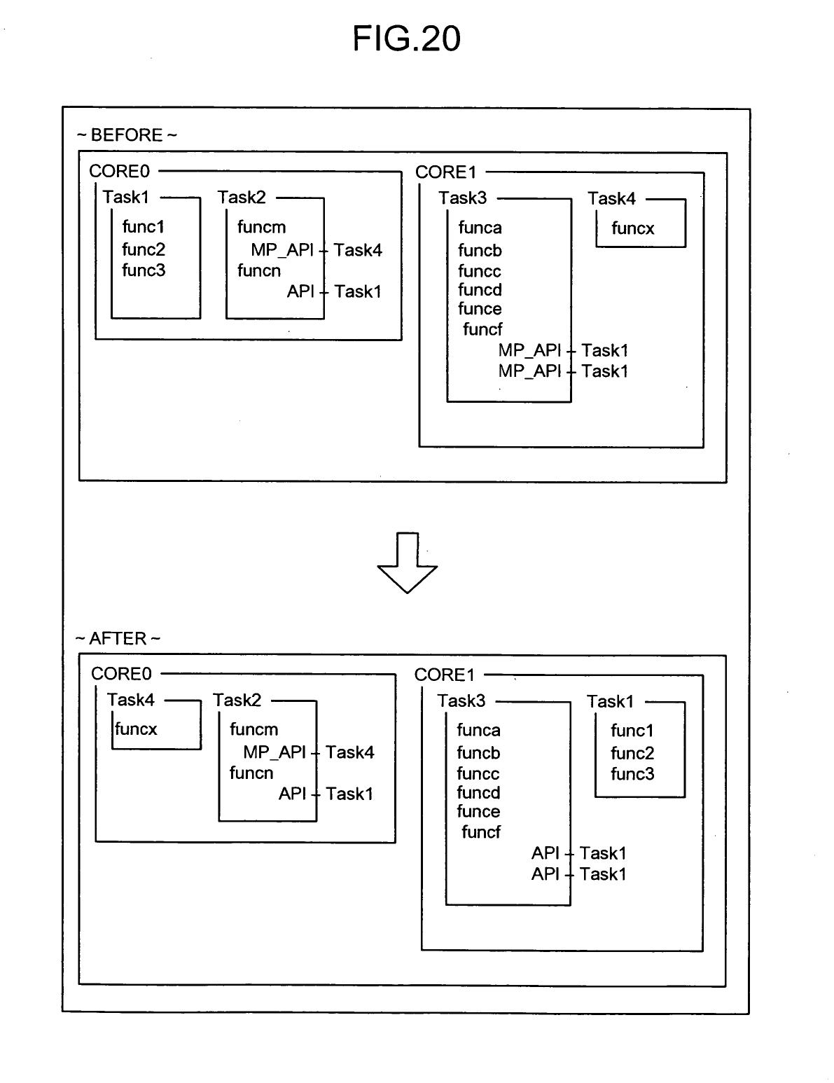

A detailed example of the tuning process step described at step S305 of the flowchart of FIG. 3 will be described. FIGS. 19A, 19B, and 20 are schematics for illustrating an example of the tuning process.

The number of cycles of each function (func1, func2, func3) of Task1 based on the granularity information is shown in FIG. 19A. Similarly, the number of cycles of each function (funca to funcf) of Task3 is shown in FIG. 19B. Referring to FIG. 19B, it can be seen that the number of cycles of Task3 mapped in CORE1 is many (30) and cost thereof is high. Referring to the state before the tuning (Before) shown in FIG. 20, it can be learned that Task1 mapped in CORE0 through “MP_API” is referred twice.

As the state after the tuning (AFTER) shown in FIG. 20, Task3 and Task1 are placed in the same core, CORE1, and alteration to ordinary (in the same core) communication “API” is executed from core communication, “MP_API” having the highest load. Instead, Task4 that depends on Task2 is moved to CORE0. In this manner, the tuning process step is executed.

As described above, according to the embodiment, tuning to developing engineers can be executed effectively by administering, and providing to the engineer, the granularity information that is the static granularity of a program to be tuned, structure information, dependence information, and performance information.

The tuning support apparatus and the tuning support method described in the embodiment can be realized by executing a program prepared in advance on a computer such as a personal computer, a work station, etc. This program is recorded on a computer-readable recording medium such as an HD, an FD, a CD-ROM, an MO, a DVD, etc., and is executed by being read from the recording medium by the computer. This program may be a transmission medium distributed through a network such as the Internet.

According to the embodiments described above, it is possible to execute efficient tuning.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A tuning support apparatus that supports software tuning for a multi-core processor having a plurality of cores, comprising:
an acquiring unit configured to acquire granularity information on granularity assigned to each core; and
an output unit configured to output the granularity information.

2. The tuning support apparatus according to claim 1, further comprising a registering unit configured to register performance information indicative of a load set in advance depending on a type of function included in a task, wherein
the output unit is configured to further output the performance information.

3. The tuning support apparatus according to claim 1, wherein each of the functions is related to a process executed across multiple tasks or multiple cores.

4. A tuning support apparatus that supports software tuning for a multi-core processor having a plurality of cores, comprising:
an acquiring unit configured to acquire granularity information on granularity assigned to each core;
a creating unit configured to calculate a frequency of appearance for each task or for each function included in a task, based on the granularity information, and to create structure information indicative of the frequency; and
an output unit configured to output at least the structure information among the structure information and the granularity information.

5. The tuning support apparatus according to claim 4, further comprising a registering unit configured to register performance information indicative of a load set in advance depending on a type of function, wherein
the output unit is configured to further output the performance information.

6. The tuning support apparatus according to claim 4, wherein each of the functions is related to a process executed across multiple tasks or multiple cores.

7. A tuning support apparatus that supports software tuning for a multi-core processor having a plurality of cores, comprising:
an acquiring unit configured to acquire granularity information on granularity assigned to each core;
a creating unit configured to create dependence information on dependence on other tasks or functions for each task or for each function included in a task, based on the granularity information; and
an output unit configured to output at least the dependence information among the dependence information and the granularity information.

8. The tuning support apparatus according to claim 7, further comprising a registering unit configured to register performance information indicative of a load set in advance depending on a type of function, wherein
the output unit is configured to further output the performance information.

9. The tuning support apparatus according to claim 7, wherein each of the functions is related to a process executed across multiple tasks or multiple cores.

10. A computer-readable recording medium that stores therein a computer program for supporting software tuning for a multi-core processor having a plurality of cores, the computer program making a computer execute:
acquiring granularity information on granularity assigned to each core; and
outputting the granularity information.

11. A computer-readable recording medium that stores therein a computer program for supporting software tuning for a multi-core processor having a plurality of cores, the computer program making a computer execute:
acquiring granularity information on granularity assigned to each core;
calculating a frequency of appearance for each task or for each function included in a task, based on the granularity information;
creating structure information indicative of the frequency; and
outputting at least the structure information among the structure information and the granularity information.

12. A computer-readable recording medium that stores therein a computer program for supporting software tuning for a multi-core processor having a plurality of cores, the computer program making a computer execute:
acquiring granularity information on granularity assigned to each core;
creating dependence information on dependence on other tasks or functions for each task or for each function included in a task, based on the granularity information; and
outputting at least the dependence information among the dependence information and the granularity information.

13. A tuning support method of supporting software tuning for a multi-core processor having a plurality of cores, comprising:
acquiring granularity information on granularity assigned to each core; and
outputting the granularity information.

14. A tuning support method of supporting software tuning for a multi-core processor having a plurality of cores, comprising:
acquiring granularity information on granularity assigned to each core;
calculating a frequency of appearance for each task or for each function included in a task, based on the granularity information;
creating structure information indicative of the frequency; and
outputting at least the structure information among the structure information and the granularity information.

15. A tuning support method of supporting software tuning for a multi-core processor having a plurality of cores, comprising:
acquiring granularity information on granularity assigned to each core;
creating dependence information on dependence on other tasks or functions for each task or for each function included in a task, based on the granularity information; and
outputting at least the dependence information among the dependence information and the granularity information.
